(19) United States
(12) Patent Application Publication
(10) Pub. No.: US 2006/0238311 A1
(43) Pub. Date: Oct. 26, 2006

(54) Wireless sensor analysis monitor

(75) Inventors: Robert M. Harman, Troutville, VA (US); Philip R. Couch, Honiton (GB); Jerry W. Fleming, Moneta, VA (US); David M. Dixon, Salem, VA (US)

Correspondence Address: MUELLER AND SMITH, LPA;MUELLER-SMITH BUILDING, 7700 RIVERS EDGE DRIVE, COLUMBUS, OH, 43235, US

(73) Assignee: IHS iMonitoring Inc., Englewood, CO (US)

(21) Appl. No.: 11/255,788

(22) Filed: Oct. 21, 2005

Related U.S. Application Data
(60) Provisional application No. 60/621,510, filed on Oct. 21, 2004.
(60) Provisional application No. 60/624,637, filed on Nov. 2, 2004.

(51) Int. Cl. G09F 25/00

(52) U.S. Cl. 340/286.01

(57) ABSTRACT

A monitoring device adapted to monitor a condition includes a sensor that produces an output signal representative of the condition, a filter configured to at least partially operate on the output signal, a sampling arrangement adapted to sample the output signal at a predetermined frequency to thereby collect a plurality of samples, and an analysis arrangement adapted to at least partially analyze the plurality of samples to thereby produce data. The filter has a controllable knee the knee is related to the sample frequency.

### CROSS-REFERENCES TO RELATED APPLICATIONS

This application is a non-provisional of, and claims the benefit of, co-pending, commonly-assigned, Provisional U.S. Patent Application No. 60/621,510 (Attorney Docket No. 040050-002400US) entitled “DIGITALLY SYNTHESIZED ACQUISITION,” filed on Oct. 21, 2004, the entirety of which application is incorporated herein for all purposes.

This application is related to co-pending, commonly-assigned, Provisional U.S. Patent Application No. 60/624,637 (Attorney Docket No. 040050-002300US) entitled “SENSOR ANALYSIS MONITOR,” filed on Nov. 2, 2004, the entirety of which application is incorporated herein for all purposes.

### STATEMENT AS TO RIGHTS TO INVENTIONS MADE UNDER FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. N00024-02-C-4124 awarded by the Navy.

### BACKGROUND OF THE INVENTION

Embodiments of the present invention relate generally to monitoring systems. More specifically, embodiments of the invention relate to sensors and associated processing systems.

Industrial complexes often require a variety of parameters to be measured and analyzed. This promotes safety, security, efficiency, and a number of other desirable features. The more efficiently the parameters are measured, the more efficient the complex operates, generally.

Many complexes are distributed over vast distances. Many locations that require monitoring have limited access to power and communications infrastructure. Hence, for these and other reasons, it is desirable to have adaptable sensors capable of operation in such environments.

### BRIEF SUMMARY OF THE INVENTION

Embodiments of the invention thus provide a monitoring device adapted to monitor a condition. The monitoring device includes a sensor that produces an output signal representative of the condition, a filter configured to at least partially operate on the output signal, a sampling arrangement adapted to sample the output signal at a predetermined frequency to thereby collect a plurality of samples, and an analysis arrangement adapted to at least partially analyze the plurality of samples to thereby produce data. The filter has a controllable knee and the knee is related to the sample frequency.

In some embodiments the monitoring device includes a Direct Digital Synthesizer configured to generate a clock signal determinative of the sample frequency and the knee. The filter may be a low-pass filter. The filter may be an anti-aliasing filter. The device may include a storage arrangement configured to at least temporarily store the data and a communications arrangement configured to transmit at least a portion of the data. The communications arrangement may be a wireless communication arrangement. The condition may be vibration and the sensor may be an accelerometer. The data may relate to a frequency of the vibration. The data may relate to an amplitude of the vibration. The data may relate to a phase of the vibration. The analysis arrangement may be configured to perform a Discrete Fourier Transform on the plurality of samples. The device may include a battery for powering the monitoring device. The device may include a digital to analog converter for converting the output signal into a digital data stream. The data may have at most three states indicative of the condition. A first state may be a normal state and a second state may be an upset state.

In other embodiments, a data processing circuit includes a data sampling arrangement configured to sample a signal at a sample frequency to thereby produce a plurality of samples, a processing arrangement configured to at least partially process the plurality of samples into data, and a filter configured to operate on the signal. A corner frequency of the filter is at least partially adjustable by the processing arrangement. The corner frequency and the sample frequency are related.

The data processing circuit may include a Direct Digital Synthesizer configured to generate a clock signal determinative of the sample frequency and the corner frequency. The processing arrangement may be further configured to perform a Discrete Fourier Transform on the plurality of samples. The circuit may include a communications arrangement configured to wirelessly communicate at least a portion of the data to a remote receiver. The data may include at most three states indicative of a condition monitored by the monitoring arrangement. The sample frequency may be a multiple of the corner frequency.

In still other embodiments, a monitoring device includes an accelerometer configured to monitor vibration and produce a signal representative of the vibration, a programmable low-pass filter configured to receive the signal and produce a conditioned signal, an analog-to-digital converter configured to produce a digital data stream relating to the conditioned signal, and a processor configured to at least partially process a sampling of the digital data stream by performing a Discrete Fourier Transform of at least a portion of the digital data stream to thereby produce data, control the low-pass filter, via a direct digital synthesizer in response to the data, and at least temporarily store the data. The monitoring device may include a wireless communications arrangement configured to transmit at least a portion of the data to a remote receiver.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 provides a distributed monitoring system according to embodiments of the invention.

FIG. 2 illustrates a vibration sensor according to embodiments of the invention, which vibration sensor may be employed in the system of FIG. 1.

FIG. 3 illustrates an exploded view of the vibration sensor of FIG. 2.

FIG. 4 illustrates a pressure sensor according to embodiments of the invention, which vibration sensor may be employed in the system of FIG. 1.

FIG. 5 illustrates an exploded view of the pressure sensor of FIG. 4.

FIG. 6 illustrates a temperature sensor according to embodiments of the invention, which vibration sensor may be employed in the system of FIG. 1.

FIG. 7 illustrates an exploded view of the temperature sensor of FIG. 6.

FIG. 8 illustrates a first exemplary acquisition circuit according to embodiments of the invention, which acquisition circuit may be used with the vibration sensor of FIG. 2.

FIG. 9 illustrates a second exemplary acquisition circuit according to embodiments of the invention, which acquisition circuit may be used with the vibration sensor of FIG. 2.

### DETAILED DESCRIPTION OF THE INVENTION

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

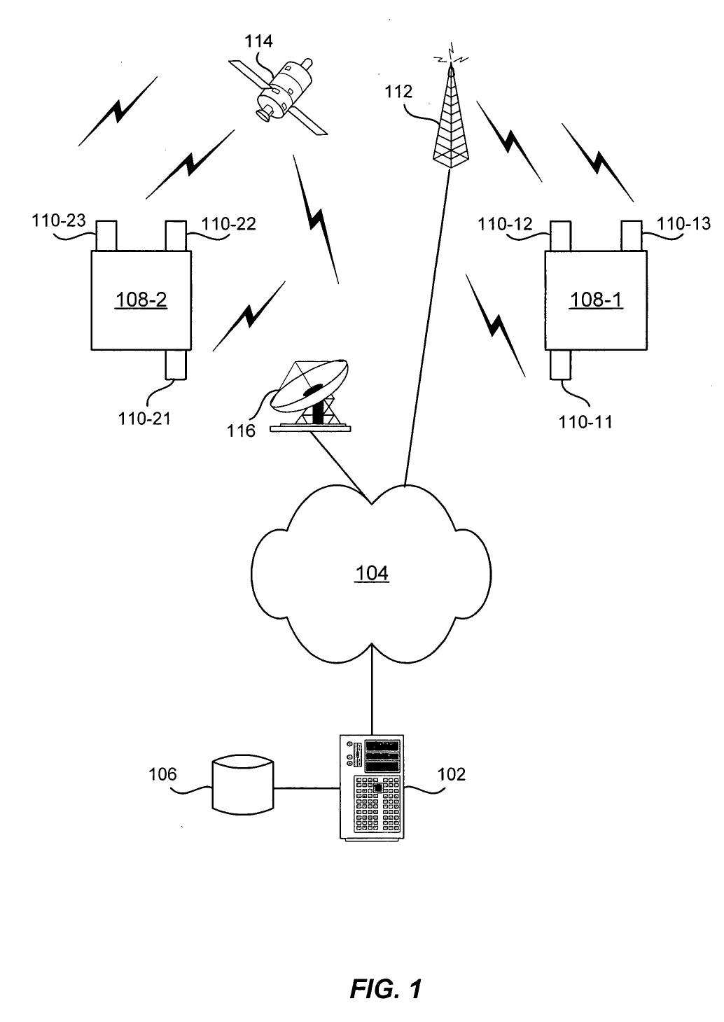

FIG. 1 illustrates a distributed monitoring system 100 according to embodiments of the invention. Those skilled in the art will appreciate that the system 100 is merely exemplary of a number of possible systems according to embodiments of the invention. The system 100 may be distributed across a vast geographical area or may be locate within a single facility. The system includes a data processing server 102 and a network 104 through which data are collected. The system 100 also includes a database for housing data. The data processing server 102 may be any of a variety of well-know computing devices, including, for example, a server, a workstation, a personal computer, a mainframe, and/or the like. The network 104 may be a Wide Area Network, a Local Area Network, the Internet, and/or any of a number of other types and varieties of networks, as is apparent to those skilled in the art. The database 106 may be nay of a variety of storage systems, including, for example, magnetic, optical, solid state, and/or the like.

The system 100 includes two monitored devices 108, although other exemplary systems include may additional monitored devices. The monitored devices 108 may be, for example, tanks, piping systems, processing systems, fluid and gas systems, electrical systems, and/or the like. Sensors 110 are placed at various points on the monitored devices 108 to collect, and in some cases process, data. As will be explained in more detail hereinafter, the sensors may be, for example, temperature sensors, pressure sensors, vibration sensors, and/or the like.

The sensors 110 transmit data to the processing server 102 through any of a variety of paths. For example, the sensors 110-1 transmit information via a generally terrestrial path. Signals from the sensors 110-1 are transmitted via a land-based receiving tower 112 that may be hard wired to the network 104, although retransmitting wireless signals is also a possibility. The sensors 110-2 transmit signals to a satellite 114 that retransmits the signals to a ground-based receiver 116. Those skilled in the art will appreciate many such examples in light of the disclosure herein.

The signaling of the system 100 may follow any of a variety of protocols. For example, the sensors 110 may be polled periodically by the data processing server 102. When a sensor 110 is interrogated, it responds with either real-time or stored data. In some embodiments, the data is a compilation of processed data, while in other embodiments, the sensor 110 transmits raw data. In some embodiments, sensors are configured to transmit upon the detection of an upset condition or upon the occurrence of any of a number of predetermined events. In still other embodiments, the sensors 110 transmit data according to a predetermined schedule. Although impractical, some sensors may be configured to transmit continuously. In any of the foregoing, handshaking may be employed to ensure data are received. Many other examples exist, including combinations of the foregoing.

As previously stated, some sensors 110 may do some level of pre-processing. Such sensors have the advantage of low power utilization, since data transmission is typically the highest power consumption function the sensors perform. This will be described in greater detail hereinafter.

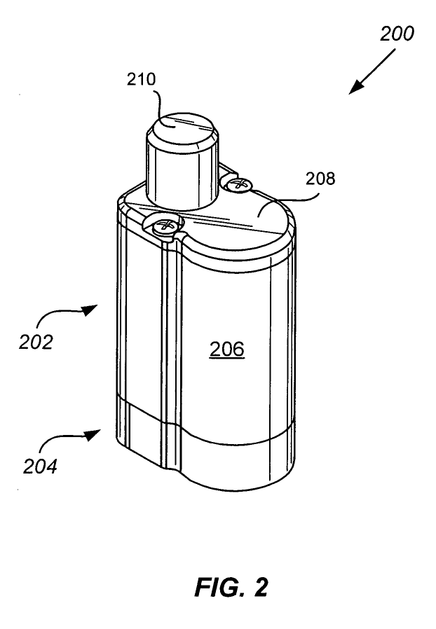

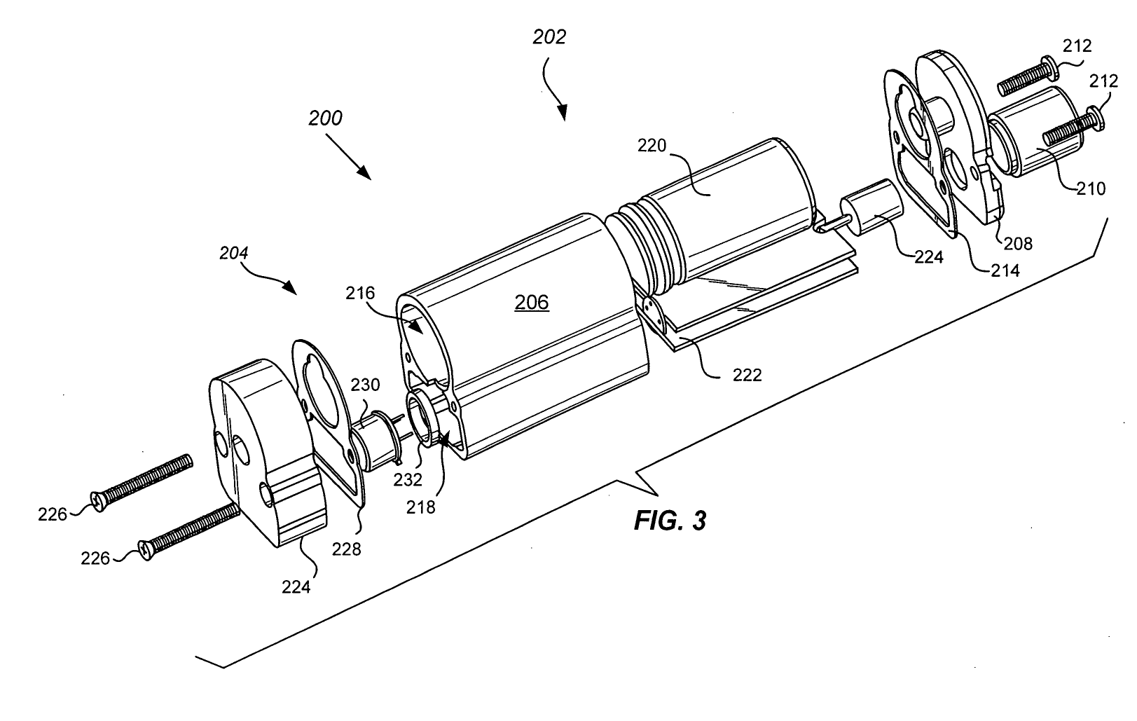

FIGS. 2 and 3 illustrate a vibration sensor 200 according to embodiments of the invention. Any of the sensors 110 in the system 100 may be a vibration sensor. The vibration sensor 200 is a self-contained unit that can be attached to anything that might move or vibrate. Movement is sensed by an accelerometer. The sensed movement is processed by circuitry within the sensor and transmitted to other networked devices or a central processor, i.e., the data processing server 102. Acceleration may be measured in one, two or three axis, depending upon the embodiment.

The vibration sensor includes an acquisition module 202 and a sensor module 204. The acquisition module 202 includes a body 206, an acquisition module cover 208, an antenna cover 210, and fastening hardware 212. A gasket 214 may be placed between the cover 208 and the body 206 to form a weather tight seal. The body 206 forms two compartments: a battery compartment 216 and an electronics compartment 218. The battery compartment 216 houses a battery 220. The electronics compartment 218 houses one or more printed circuit boards (PCB) 222. An antenna 224 is attached to one of the PCB 222.

The sensor module 204 includes a sensor cover 224 and fastening hardware 226 that attaches the cover 224 to the body 206. A gasket 228 may be included. The sensor module 204 houses an accelerometer 230 that is held fast with a hold down ring 232. The PCB is designed with flexible material such that a direct connection can be made with the accelerometer.

In a specific embodiment, the vibration sensor includes two PCBs and an 800 mAH battery in a single Li-ION cell. The first circuit card includes a radio and processor. The second circuit card includes circuitry to condition and bias the accelerometer. In other embodiments, the various circuit elements could be divided in any way between the two PCBs. A connector couples the first and second circuit cards together, and a flex circuit couples the PCBs to the battery.

As will become apparent from the ensuing description, the acquisition module 202 generally may be considered “universal” in that core components of the acquisition module 202 are adaptable for use with a variety of sensor modules. For example, the body 206, acquisition module cover 208, antenna cover 210, and fastening hardware 212, are the same components in each of the sensors herein described. Further, the body 206 has a form factor in which standard components having a compatible form factor may be housed. For example, while different batteries, antennas, and PCBs may be used with different sensors, the specific battery, PCB, and sensor used may be chosen or designed to fit within the standard acquisition module 202. The acquisition module 202 may be configured for integration with any of a variety of sensors, including, for example, a pressure sensor or a temperature sensor, as will be described. Other parameters that may be monitored include speed, distance, illumination, acidity, time, location, depth, fill level, motion, and/or the like.

The body 206 may be made of a durable material suitable for the environment in which the sensor 200 is to be deployed. For example, the body may be made of stainless steel, titanium, carbon fiber, any of a variety of plastic materials, other metals, and the like. In a specific embodiment, the body displaces no more than 1.62 cubic inches. Various other embodiments could displace 1 or more, 2 or more, 3 or more, or 4 or more cubic inches.

In a specific embodiment, the battery 220 is not rechargeable, but provides months or years of power depending on the frequency of sensor measurements and/or radio communications. In other embodiments, the battery 220 could be rechargeable. Some embodiments could include a photovoltaic cell to recharge the battery.

Since frequent radio transmissions generally decrease battery life, radio transmissions may be made infrequent by performing some amount of analysis within the sensor. The sensor can be configured to receive programming, configuration, and/or firmware updates via wireless transmission. In a specific embodiment, transmissions are via unlicensed 900 Mhz frequency band, but other embodiments could use any licensed or unlicensed frequency.

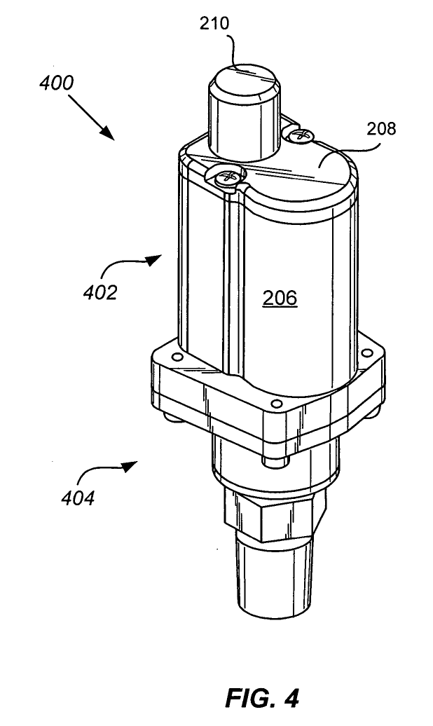

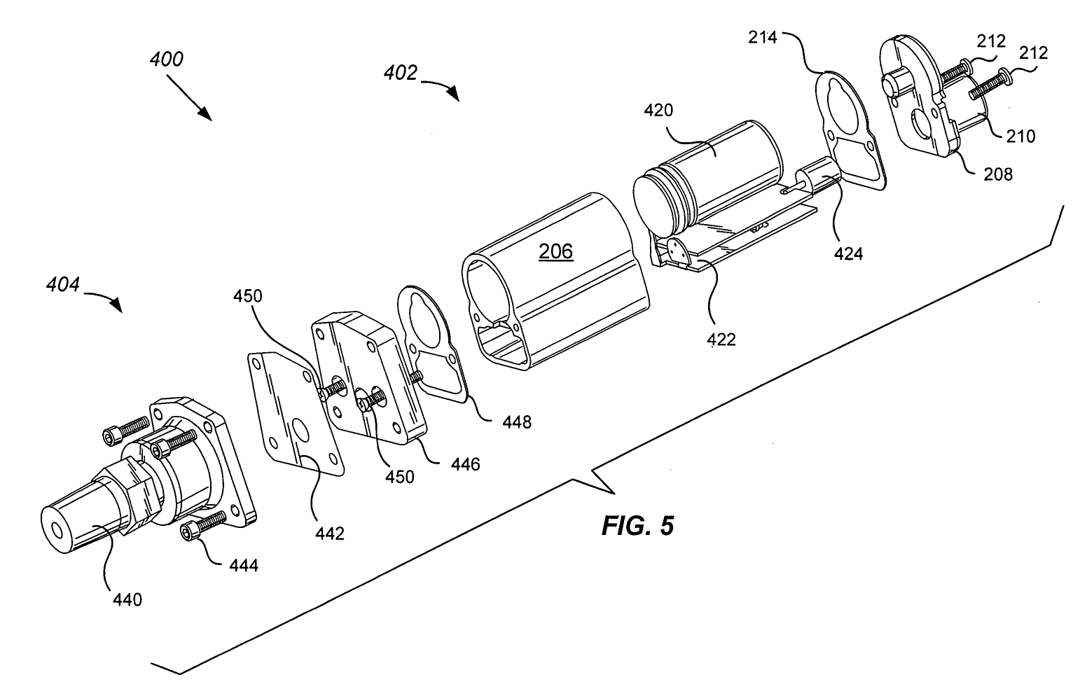

FIGS. 4 and 5 illustrate a pressure sensor 400 according to embodiments of the invention. The pressure sensor 400 is self-contained and can be mounted anywhere a pressure reading is desired. The pressure can be measure in dry or wet environments. The measured data can be radio-transmitted to a network of other devices. The pressure sensor 400 includes an acquisition module 402 and a sensor module 404. The battery 420, PCB(s) 422, and antenna 424 are specifically designed to work with the sensor module 404, but may share many common features with the analogous components of the vibration sensor 200. The pressure sensing module 404 of the pressure sensor assembly 400 is attached to body using an adapter bushing 446 and screws 450. The actual pressure sensing mechanism makes use of a standard resistive bridge and diaphragm configured in a custom form factor, 440. Gaskets 448 and 446 may be included.

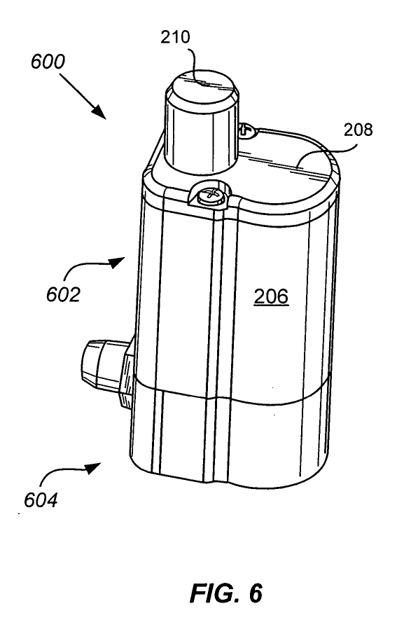

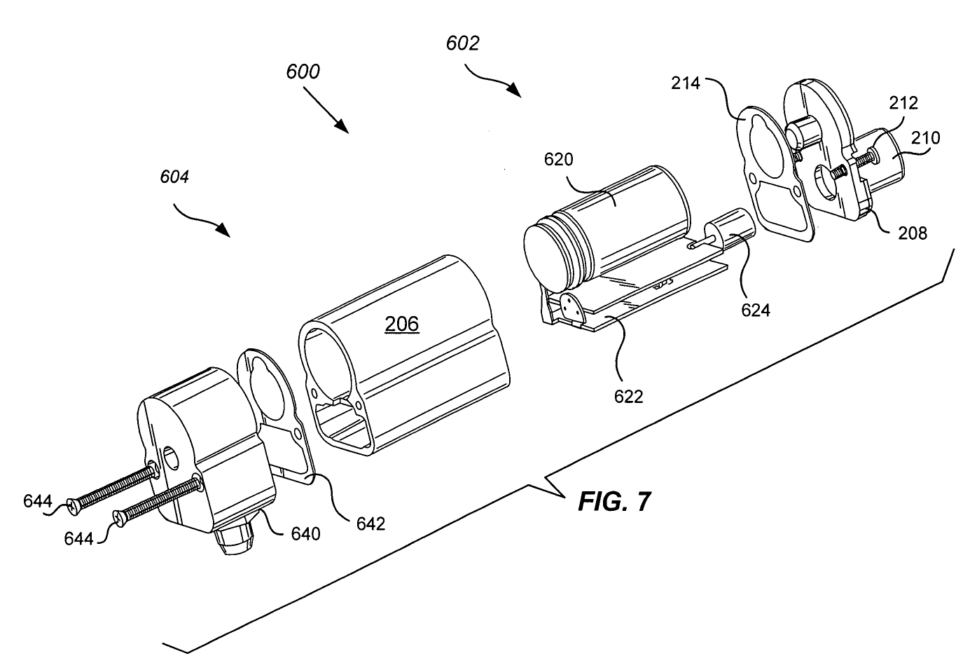

FIGS. 6 and 7 illustrate a temperature sensor 600 according to embodiments of the invention. The temperature sensor 600 may be self-contained or may be configured to connect to external temperature sensing devices via a hardwired connection. A connector is provided 640 to accommodate an external temperature sensing probe. The temperature sensor can measure temperature in a dry or wet environment. The temperature sensor 600 includes an acquisition module 602 and a sensor module 604. The battery 620, PCB(s) 622, and antenna 624 are specifically designed to work with the sensor module 604, but may share many common features with the analogous components of the vibration sensor 200 and the pressure sensor 400. The temperature sensor module/interface module 604 of the temperature sensor 600 includes a probe connector 640. The temperature sensor module 605 is attached to the body 206 using fastening hardware 644. A gasket 642 may be included.

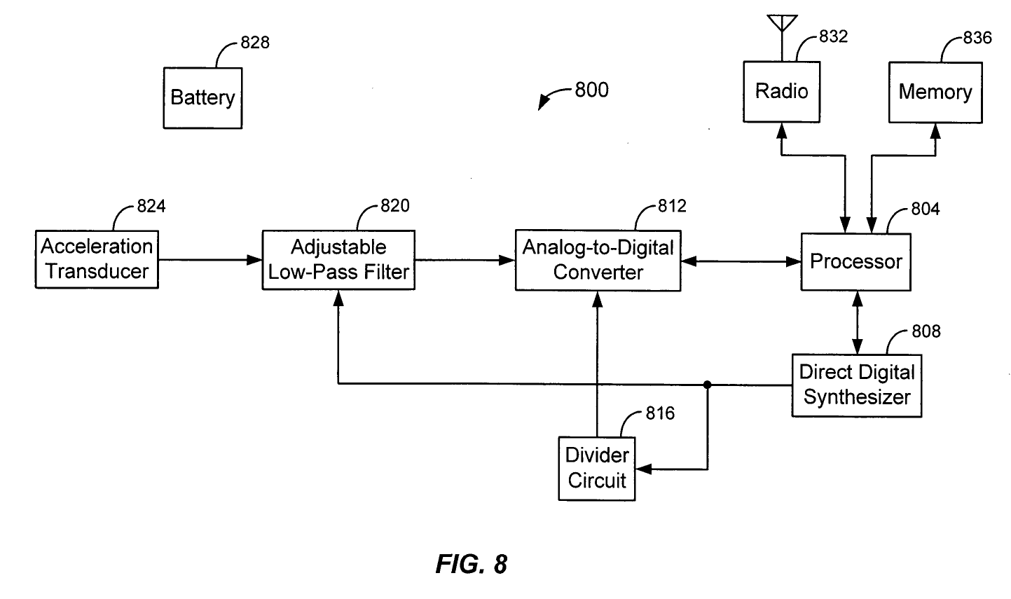

Having described several sensors according to embodiments of the invention, attention is directed to FIG. 8, which illustrates a block diagram of a vibration acquisition and analysis circuit 800 according to embodiments of the invention. The circuit 800 may be employed in the vibration sensor 200, as will be appreciated by those skilled in the art. The circuit 800 is configured to process measurements to thereby decrease the amount of information to be transmitted, which conserves power.

In some embodiments of the vibration acquisition and analysis circuit 800, it is desirable to reduce the data set to a minimum without compromising the analysis. This reduces the computation energy and/or reduces the amount of data to be transmitted if raw samples or resulting discrete Fourier Transform (DFT) set is to be sent by radio, both of which increase battery life. Longer battery life leads to lower maintenance. For example, halving the battery energy used with each computation or transmission may increase the maintenance period by up to a factor of two, e.g. typically from 6 months to one year.

In such embodiments, a DFT is generated from a set of equally spaced samples of instantaneous signal taken from an accelerometer, which samples are transformed to yield the amplitude of a frequency of period equal to the full sample set duration, and all harmonic frequencies thereof up to a frequency of period equal to just two sample periods. These values at each of the discrete set of frequencies are also often known as bins. A typical sample set comprises 256 samples, and after the DFT transform provides amplitudes of a frequency of period spanned by the 256 samples and 127 harmonics thereof. If for example the sample rate were 256 k samples/sec, then the DFT would yield amplitude of signals at 1 kHz, 2kHz, etc., up to 128 kHz.

In analyzing vibrations from a rotating machine, it is assumed that the vibrations are primarily at the rotation frequency and/or harmonics thereof. The DFT must be computed so as to provide sufficient resolution and information about the rotation frequency and its harmonics. Since the DFT only analyzes a discrete set of frequencies, an arbitrary sample set must be large and finely spaced to ensure the resulting DFT is sufficiently detailed to resolve the frequencies of interest.

It is useful, then, to make the sample set duration exactly equal to one rotational period for the machine. Then the resulting DFT evaluates exactly the harmonics of the rotational frequency, which is exactly what is required, without any superfluous data. Conversely, if one uses an arbitrary predefined and fixed sample rate one must ensure that the sample set (a) spans the slowest expected rotational period and (b) is of sample rate faster then twice the maximum required harmonic at the maximum rotational speed. If the rotational speed is not taken into account, this might require a huge, detailed sample set to be collected and analyzed.

In embodiments of the present invention, the sampling clock is precisely variable so that it may be set at a precise multiple of the rotational speed. Aligning the fundamental rotational frequency within a given bin is an iterative process that can be done with little user interaction, assuming you have sufficient ADC clock granularity. Essentially the aligning algorithm is written to maximize the amplitude of the fundamental frequency in the desired bin by taking several sample sets and slightly varying the sample rate until the amplitude peaks. A typical sample set of 256 samples is then adequate for deriving the amplitude of harmonics up to the 127^{th}. Conversely, if the machine speed range is known only within a factor of, say, eight, the sample set would need to be 2048 samples in order to achieve the same information if the sampling frequency were not adjusted as described herein. DFT computational time and energy typically increases as the square of the number of samples. Thus it causes a considerable penalty in the use of valuable battery energy, and in the above examples the non-frequency locked design could use 256 times as much computational energy as the frequency locked design.

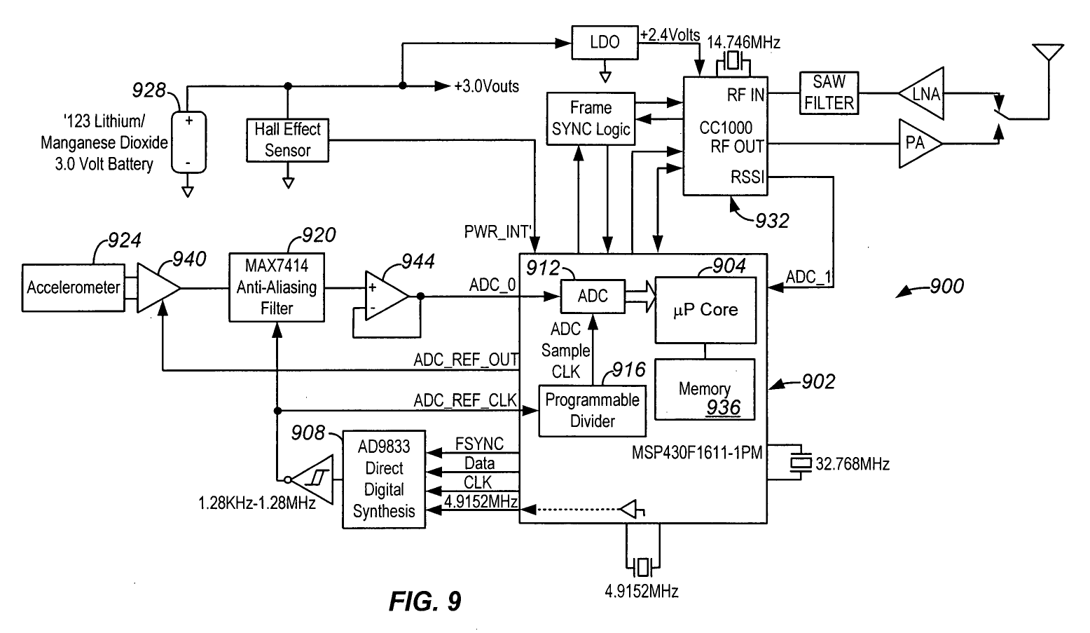

In the exemplary embodiments of FIGS. 8 and 9, the sampling frequency is generated from a crystal stabilized clock reference by a direct digital synthesizer (DDS) circuit, which is generally available as a power efficient integrated circuit device (808 and 908). DDS IC allows a simple processor to provide sub-hertz sample rate resolution. Using a DDS the sampling frequency may be digitally programmed into the DDS, for example from a simple microprocessor (804 and 902), with great accuracy and resolution. For precision in the sampling process it is necessary to low-pass-filter the incoming waveform to attenuate frequencies above the maximum DFT frequency (i.e. half the sample rate) to avoid aliasing distortion. In the current implementation the sampling rate is variable and so the low-pass-filter frequency must also be varied to track the sampling rate. This is achieved using a digital filter whose characteristic frequency is controlled by an input clock frequency. In this case the input clock frequency is also taken from the output of the same DDS as generates the sampling rate clock so that it tracks the sampling rate exactly.

There is a further reason for aligning the rotational frequency within the DFT frequency bins. In order to make an assessment of overall machine health, a good baseline sample set is typically needed. This reference set is more precise if the fundamental rotation frequency accurately aligns and peaks within the bins. With an accurate baseline and the ability to perform bin alignment, accurate comparative measures can be taken at any time in the future, or from other similar systems, and even to some extent from systems operating at different rotational rates. The system can then assess how the various harmonics deviate with respect to the baseline. Thresholds can be set to trigger alarms or warnings based on these changes. This ability allows a simple wireless device to transmit minimal data in the form of alarms or warnings, thus minimizing data transmission and maximizing battery life. Proper sample rate resolution and bin alignment allows the use of historical data in the analysis process. Using a DDS as the clock source in a wireless sensor analysis monitor permits the required frequency setting precision in a design that is compatible with the miniature, very low power requirements of a battery operated wireless sensor analysis monitor.

In a specific embodiment, the circuit 800 accomplishes this by performing a DFT on samples taken by an accelerometer to determine the frequencies of vibration sensed by the accelerometer. A direct digital synthesis circuit controls both a low pass filter, or anti-aliasing filter, and an analog-to-digital converter (ADC).

The circuit 800 includes an accelerometer 824 and an adjustable low-pass filter 820. The knee of the filter is adjusted by a direct digital synthesis circuit 808 under the direction of a processor 804. The measurements passed by the filter 820 are converted to digital signals by an analog-to-digital converter 812. The signals are thereafter passed to a processor 804.

The processor 804 receives the digital stream and performs a DFT. The processed signals may then be stored in memory 836 and/or transmitted by a radio 832. The circuit is powered by a battery 828.

Having described a general embodiment, attention is directed to FIG. 9, which illustrates a specific example of a vibration acquisition and analysis circuit 900 according to embodiments of the invention. In this embodiment, the output of an accelerometer 924 is conditioned in an amplifier 940, the gain of which is adjustable by a controller 902. The amplified output is passed to an anti-aliasing filter 920, which performs a low pass filter. In this specific embodiment, the filter 920 is a switched capacitor filter. The knee of a switched capacitor filter is proportional to the rate of a source clock. In this embodiment, a direct digital synthesis (DDS) circuit 908, also adjustable by the controller 902, serves as the source clock. The output from the filter 920 is conditioned in another amplifier 944 before being received by the controller 902 for further processing.

In this embodiment, the controller 902 includes a one megabyte memory 936, a programmable divider circuit 916, an ADC 912, and a microprocessor 904. The output of the DDS 908 is fed back into the divider circuit 916 which reduces the DDS 908 output clock rate so that a single clock source drives both the ADC 912 and the filter 920. The filter 920 uses a faster clock rate than the ADC in this embodiment. The divider circuit 916 is selected such that the ADC clock rate is a multiple (e.g., 2×, 3×, 4×, etc) of the corner frequency of the filter. In this way, the DDS 908 controls both the filter 920 and the ADC 912 via the same signal.

The ADC 912 converts the signal originating from the accelerometer 924 into a stream of digital samples. The microprocessor 904, which is a 16 bit core with about 8 MIPS of processing power, receives the digital stream and performs a DFT to determine the frequency domain of the accelerometer signal. The precise control of the direct digital synthesizer 908 affords extreme accuracy in gathering frequency information. For example, a 0.1 Hz resolution for the sample rate can be performed in this embodiment.

In some embodiments, the DFT alone does not necessarily reduce the transmitted data because the DFT generates as many values as the time domain data set. For example, a 1024 point DFT (1024 time domain samples) produces 512 real and 512 imaginary values from the DFT calculation. This results in zero savings in transmitted data if all the values are transmitted. If, however, the user wants only the magnitude or phase (mag=sqrt (realˆ2+imagˆ2), phase=arctan (imag/real)), the data set can be reduced in half. Additionally, knowing the frequency domain data allows, in some embodiments, a data set reduction by windowing (e.g., only a subset of frequencies are of interest), thresholding (e.g., only current values above or below×dB are of interest), and/or comparing (e.g., current frequency domain sample sets are of interest only if they exceed historical values by X). In some embodiments, no time or frequency domain data is sent. Instead, the sensor only reports good, bad, or marginal performance. In summary, performing the DFT onboard ‘enables’ the device to locally assess the condition of the machine being monitored by the acquisition circuit 900.

A radio 932 operates in a bi-directional manner. A remote radio can accept the processed frequency information from the radio 932 and can pass handshaking, configuration information, and the like to sensor via the radio 932. An unlicensed spectrum in the 900 MHz range is used in this embodiment, but other embodiments could use licensed or unlicensed frequency ranges (e.g, 2.4 GHz, 5.8 GHz, etc.).

A battery 928 powers the circuit 900. In this embodiment, the battery is a 3 volt, lithium/manganese dioxide battery that has an 800 mAH capacity. The acquisition circuit 900 spends most of its time in a low power mode that draws about 25 micro-Amps. Periodically, the acquisition circuit 900 powers itself up, takes a reading from the accelerometer, processes that reading and forwards the processed frequency information to another device using the radio 932. In powered mode, about 10-20 mili-Amps is consumed for a 1-3 second period before returning to low power mode. Using a battery of this type, hourly readings would allow the battery 928 to last about 2 months. Daily samples would allow the battery 928 to last about a year. Some embodiments can last up to five years on the same battery.

Although this embodiment processes information from an acceleration sensor, other embodiments could process information from any type of sensor. For example, the sensor could measure pressure, temperature, flow, or other parameters.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention, which is defined in the following claims.

What is claimed is:

1. A monitoring device adapted to monitor a condition, the monitoring device comprising:
a sensor that produces an output signal representative of the condition;
a filter configured to at least partially operate on the output signal;
a sampling arrangement adapted to sample the output signal at a sample frequency to thereby collect a plurality of samples; and
an analysis arrangement adapted to at least partially analyze the plurality of samples to thereby produce data;
wherein the filter has a controllable knee and wherein the knee is related to the sample frequency.

2. The device of claim 1, further comprising a Direct Digital Synthesizer configured to generate a clock signal determinative of the sample frequency and the knee.

3. The device of claim 1, wherein the filter comprises a low-pass filter.

4. The device of claim 1, wherein the filter comprises an anti-aliasing filter.

5. The device of claim 1, further comprising:
a storage arrangement configured to at least temporarily store the data; and
a communications arrangement configured to transmit at least a portion of the data.

6. The device of claim 5, wherein the communications arrangement comprises a wireless communication arrangement.

7. The device of claim 1, wherein the condition comprises vibration and wherein the sensor comprises an accelerometer.

8. The device of claim 7, wherein the data relates to a frequency of the vibration.

9. The device of claim 7, wherein the data relates to an amplitude of the vibration.

10. The device of claim 7, wherein the data relates to a phase of the vibration.

11. The device of claim 1, wherein the analysis arrangement is configured to perform a Discrete Fourier Transform on the plurality of samples.

12. The device of claim 1, further comprising a battery for powering the monitoring device.

13. The device of claim 1, wherein the data comprises at most three states indicative of the condition.

14. The device of claim 13, wherein a first state comprises a normal state and a second state comprises an upset state.

15. A data processing circuit, comprising:
a data sampling arrangement configured to sample a signal at a sample frequency to thereby produce a plurality of samples;
a processing arrangement configured to at least partially process the plurality of samples into data; and
a filter configured to operate on the signal, wherein a corner frequency of the filter is at least partially adjustable by the processing arrangement and wherein the corner frequency and the sample frequency are related.

16. The circuit of claim 15, further comprising a Direct Digital Synthesizer configured to generate a clock signal determinative of the sample frequency and the corner frequency.

17. The circuit of claim 15, wherein the processing arrangement is further configured to perform a Discrete Fourier Transform on the plurality of samples.

18. The circuit of claim 15, further comprising a communications arrangement configured to wirelessly communicate at least a portion of the data to a remote receiver.

19. The circuit of claim 15, wherein the sample frequency is a multiple of the corner frequency.

20. A monitoring device, comprising:
an accelerometer configured to monitor vibration and produce a signal representative of the vibration;
a programmable low-pass filter configured to receive the signal and produce a conditioned signal;
an analog-to-digital converter configured to produce a digital data stream relating to the conditioned signal;
a processor configured to:
at least partially process a sampling of the digital data stream by performing a Discrete Fourier Transform of at least a portion of the digital data stream to thereby produce data;
control the low-pass filter, via a direct digital synthesizer in response to the data; and
at least temporarily store the data; and
a wireless communications arrangement configured to transmit at least a portion of the data to a remote receiver.
